(19) United States
(12) Patent Application Publication
(10) Pub. No.: US 2005/0008930 A1
(43) Pub. Date: Jan. 13, 2005

(54) Core pin for a battery

(76) Inventors: Michael W. Johnson, St. Louis Park, MN (US); Shawn D. Eggum, Lonsdale, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/844,038

(22) Filed: May 12, 2004

Related U.S. Application Data
(60) Provisional application No. 60/471,052, filed on May 16, 2003.

(51) Int. Cl. H01M 2/02; H01M 2/12

(52) U.S. Cl. 429/94; 429/164; 429/53

(57) ABSTRACT

Improved batteries, such as rechargeable batteries, comprise an anode, a cathode, a separator between the anode and the cathode and a core pin. In some embodiments, the core pin comprises a flow channel in a direction along a major axis of the core pin. Due to the presence of the flow channel, the improved batteries can have the ability to reduce the build up of undesirable gases within the cell, when combined with appropriate venting. In some embodiments, the flow channel can be provided through the interior of the core pin. In other embodiments, the flow channels can be created along the outer surface of the core pin with a core pin having protrusions that define indentations around the perimeter of the pin. The core pin can be made of a polymer.

### RELATED APPLICATIONS

The present application claims the benefit of priority from U.S. Provisional Application No. 60/471,052, filed May 16, 2003, and entitled “CORE PIN FOR A BATTERY,” which is hereby incorporated in its entirety by reference.

### FIELD OF THE INVENTION

The invention relates to core pins for batteries, and in particular to core pins with structure defining a flow path for venting gases produced during use of the battery. The invention further relates to methods for venting gases within batteries.

### BACKGROUND OF THE INVENTION

Portable electronic devices, such as, for example, laptop computers, cell phones and digital cameras, generally require the use of batteries. The increased use of portable electronics devices has lead to the increased demand for batteries. Additionally, portable electronic devices are generally smaller and capable of performing more functions than previous electronic devices, which requires batteries designed for use in these devices to be smaller and have a higher energy density than previous batteries. As a result, battery designers have explored the use of different chemical schemes.

Over the last few years, lithium ion chemistry has been replacing nickel-cadmium (NiCd) and nickel-metal-hydride (NiMH) chemistries as the preferred system in certain batteries. This shift is due in part to the smaller size, lighter weight and higher energy density of lithium ion batteries as compared with other systems. Thus, lithium based batteries can have higher energy outputs per unit weight and volume, which makes lithium based batteries suitable for use in, for example, portable electronic devices. Additionally, lithium based batteries can have better cycling properties than other batteries.

Batteries generally can be primary batteries that are designed for a single discharge prior to disposal or recycling, or secondary batteries that are rechargeable such that they can be cycled by recharging the battery after a discharge. Lithium based batteries can have a lithium metal anode, which in particular can be used to form primary batteries. Lithium based secondary batteries generally have a lithium intercalation compound in the anode, such as graphitic carbon or certain metal oxides, such as tin oxide.

Currently, there are two types of lithium ion batteries on the market. The first type employs a liquid electrolyte, while the second uses a solid-polymer electrolyte and can be referred to as a lithium polymer battery. In general, both types of lithium ion batteries operate on what is known as the “rocking chair” effect. The “rocking chair” effect involves the transfer of lithium between the anode and the cathode of the battery during the charging and discharging cycles. This effect can provide lithium ion batteries with longer shelf life and longer cycle life relative to other batteries. Typically, the anode of lithium ions batteries comprises lithium incorporated into carbon, tin oxide or the like. The cathode of a lithium ion battery generally comprises a metal composition with a chalcogen, such as metal oxides, including, for example, lithium cobalt oxide, lithium manganese oxide, or other metal oxide. In some lithium ion batteries, the electrolyte can comprise a lithium salt.

Under certain conditions, such as when a battery is improperly charged or used outside specific temperature ranges, the charging and discharging reactions can generate side products. In some instances, these side products can include gases such as hydrogen or oxygen. The build up of undesirable gases inside the battery can lead to battery malfunction and possibly to explosion of the battery. Due to the number of devices that can use batteries and the number of batteries being used by consumers, it would be desirable to reduce the build up of any generated gases within a battery.

### SUMMARY OF THE INVENTION

In a first aspect, the invention pertains to a battery comprising an electrode structure having a cathode, and anode and a separator between the anode and the cathode. The battery can further comprise a core pin comprising a polymer and having a length along a direction generally indicated by a major axis. The core pin comprises a flow channel in a direction generally along the major axis. In some embodiments, the separator, and the electrode structure are wound around the core pin.

In a further aspect, the invention pertains to a core pin for a battery comprising electrically conductive particles in a polymer binder. In these embodiments, the core pin has a flow path through the interior of the pin to an end of the pin.

In addition, the invention pertains to a method for forming a vented battery. In these embodiments, the method comprises sealing an electrode structure within a vented container comprising a pressure release valve. In some embodiments, the electrode structure comprises a cathode, an anode and a separator between the cathode and the anode, wherein the electrode structure is wound around a core pin comprising a polymer and having a flow channel connecting the core pin with the pressure release valve.

### BRIEF DESCRIPTION OF THE FIGURES

FIG. 1 is a top view of a core pin showing openings along a major axis.

FIG. 2 is a side view of a core pin showing a staggered alignment of openings along a major axis.

FIG. 3 is a cross sectional view of a core pin taken along line A-A of FIG. 1.

FIG. 4 is a bottom view of a core pin showing openings along a major axis.

FIG. 5 is a top view of a core pin with a star shape design.

FIG. 6 is a side view of a core pin with a star shape design.

FIG. 7 is a top view of a battery comprising a core pin.

FIG. 8. is a top view of a battery comprising a star shaped core pin.

FIG. 9 is a perspective view of an embodiment of a battery case showing a vent, with a core pin shown by broken lines.

### DETAILED DESCRIPTION OF THE INVENTION

Improved batteries, such as rechargeable batteries, comprise an anode, a cathode, a separator between the anode and the cathode and a core pin. In some embodiments, the core pin comprises a flow channel in a direction along a major axis of the core pin. Due to the presence of the flow channel, the improved batteries can have the ability to reduce the build up of undesirable gases within the cell, when combined with appropriate venting. In other words, the improved batteries can vent undesirable gases via the flow channel in the core pin, which can reduce internal pressure and potential malfunction of the battery. In some embodiments, the flow channel can be provided through the interior of the core pin. In other embodiments, the flow channels can be created by a core pin having protrusions that define indentations around the perimeter of the pin. In some embodiments, the core pin can be made of a polymer.

Under certain conditions, such as, for example, use of the battery outside an acceptable temperature range or improper charging of the battery, gases such as hydrogen or oxygen can be formed inside the cell. The formation of undesirable gases can result in the build up of pressure inside the cell, damage the internal structures, such as the anode or the cathode, and/or consume reactants necessary for the electrochemical reactions. In extreme situations, the build up of gases inside the cell can cause the battery to explode. One way of preventing undesirable gases from building up inside the battery is to provide and flow path, or channel, that permits gases that reach the core pin to travel along the major axis of the pin to a vent, where the gases can be expelled from the battery.

The core pins of the present disclosure can be any structure that can both provide support for the battery and create, or define, a flow path for moving gases genereated inside the battery to an appropriate vent. In general, the core pin is composed of a polymer that is formed to provide venting while having sufficient structural strength. However, in other embodiments, other materials, such as metals, may also be used. The core pin is usually located in the center of a battery such that the other components of the battery, like, for example, the anode, the cathode and the separator, are wound around the core pin. Thus, one function of the core pin can be to provide structural support for the other components of the battery such that the electrodes stay in a desired position without any short circuits or significant increases in electrical resistance. Additionally, the core pin should be able to maintain its shape under temperatures and pressures associated with battery operation, so that the flow channels(s) are not compromised by deformation of the core pin.

The overall shape of the core pin can be generally cylindrical with a major axis along the length of the pin, and a minor axis across the diameter perpendicular to the major axis. Generally, the major axis is significantly elongated relative to the minor axis, and the pin has structure defining a flow channel along the major axis. Flow channels can be located in the interior of the pin, along the outer surface of the pin, or a combination thereof. In embodiments where a flow channel is located in the interior of the pin, the pin can have, for example, a substantially circular cross section or an oval cross section. In embodiments where the flow channel is located along the exterior surface of the pin, the pin may have a star shaped cross section or other shape having protrusions that support the battery electrodes while forming a gap that is the flow channel. No particular pin shape is required by the present disclosure.

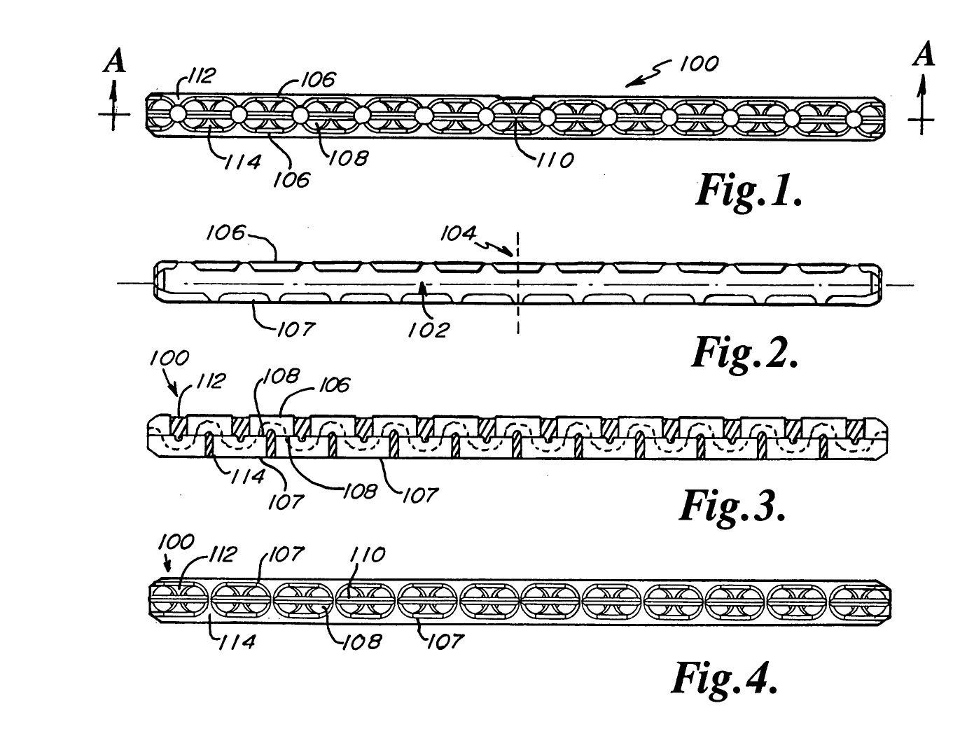

Referring to FIG. 1, an embodiment of a core pin 100 is shown. As shown in FIG. 1, core pin 100 comprises a major axis 102 and a minor axis 104. In one embodiment, a plurality of notches 106, 107 can be provided in a spaced apart relationship along two opposite sides of core pin 100 parallel to major axis 102. In some embodiments, two opposite sides of pin 100 each comprise a parallel set of notches 106, 107, where each set of parallel notches is separated by center support 110. Center support 110 generally runs along the entire length of major axis 102 and functions to improve the structural stability and mechanical strength of core pin 100. In some embodiments, notches 106, 107 can be oval or the like although other shapes can be used that provide the physical relationships described herein. Individual notches 106, 107 generally can be separated from adjacent notches along the same side of pin 100 by spacers 112, 114, respectively. With respect to FIG. 2, in one embodiment, the notches can be staggered such that notches 106 on one side of core pin 100 do not identically align with notches 107 on another side.

Generally, as shown in FIG. 2, notches 106, 107 are provided on at least two sides of core pin 100, and are cut such that they do not fully extend though pin 100. Referring to FIG. 1, pin 100 further comprises a plurality of passages 108, which connect a notch 106 with a notch 107. Thus, passages 108 form a flow path through the interior of core pin 100 between staggered notches 106, 107. Each notch 106, 107 generally connects with two passages 108 that connect two adjacent notches on the opposite sides of core pin 100 to form the flow path that progresses along major axis 102.

As described above, in some embodiments, notches 106, 107 can be provided on at least two sides of core pin 100. The staggered arrangement of notches 106,107, along with passages 108, defines a flow channel that winds through core pin 100 along major axis 102 between the top and bottom. The flow path, or channel, defined by staggered arrangement of notches 106, 107 can be seen in FIG. 3, which is a cross sectional view of FIG. 1 taken along line A-A. As shown in FIG. 3, a fluid can travel through the interior of core pin 100, along major axis 102, as noted by the dashed line. The combination of center support 110, notches 106, 107 and passages 108 allows core pin 100 to provide structural support and a flow channel for venting gases. One of ordinary skill in the art will recognize that additional shapes, sizes and configurations of notches and passages are contemplated and within the scope of the present disclosure.

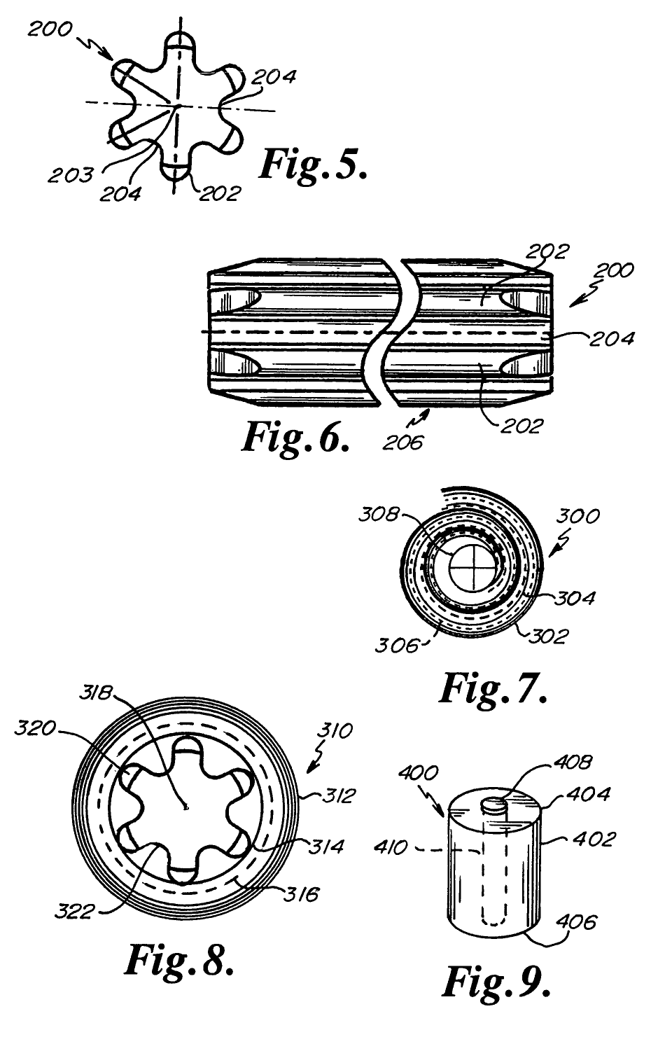

Referring to FIGS. 5 and 6, another embodiment of a core pin is shown. In this embodiment, core pin 200 has a plurality of protrusions 202 that extend outward from the center 203 of pin 200 and generally form a star shaped cross section. In some embodiments, core pin 200 can have a plurality of indentations 204 that are aligned parallel to, and run the length of, major axis 206 (FIG. 6). When core pin 200 is assembled into a battery, protrusions 202 can contact the other components of the battery, which can be wound around core pin 200. Protrusions 202 generally function to support the electrodes, while indentations 204 remain unobstructed. Thus, in one embodiment, indentations 204 can remain open and can form six channels that run along major axis 206 of core pin 200. These channels can provide a flow path for any gases produced inside the battery. In other embodiments, pin 200 may have 3, 4 or 5 protrusions, and in further embodiments pin 200 can have 7 or more protrusions. One of ordinary skill in the art will recognize that no particular number of indentations or protrusions is required by the present disclosure. Additionally, other embodiments of pin 200 can have a screw shape where the flow path is defined by a channel that runs along the outside of pin 200 in corkscrew pattern or other curved configurations.

The core pins of the present invention can be made of any polymer suitable for use in battery applications. The polymer should be selected such that the polymer is chemically resistant to the other components of the battery. The polymer can be a homopolymer, copolymer, block copolymer or a polymer blend or mixture. Suitable polymers for the core pin include, for example, polyethylene, polypropylene, poly(vinyl chloride), and poly(vinylidene fluoride). In general, the core pin can be formed by any process suitable for producing shaped plastic articles, such as, for example, injection molding and compression molding. One of ordinary skill in the art will recognize that additional polymers and methods for producing core pins are contemplated and are within the scope of the present disclosure.

In some embodiments, fillers, such as electrically conductive fillers, plasticisers, mold release agents, or combinations thereof, may be included in the polymer. Suitable electrically conductive fillers include, for example, graphite, carbon black, metal powders and combinations thereof. In some embodiments, the fillers can be present in a concentration of less than about 35 percent by weight, in other embodiments from about 5 percent to about 25 percent by weight and in further embodiments from about 0.5 percent to about 5 percent by weight.

Referring to FIG. 7, battery 300 comprises anode 302, cathode 304, separator 306 and core pin 308. In this embodiment, the components of battery 300, i.e., cathode 304, anode 302, are wound around core pin 308 to form a battery structure. In some embodiments, core pin 308 can comprise a pin with a flow channel through the center of core pin 300, which can permit gases to travel along the major axis of pin 300 to an appropriate vent. Referring to FIG. 8, another embodiment of a battery is shown. In this embodiment, battery 310 comprises anode 312, cathode 314, separator 316 and center pin 318. As shown in FIG. 8, center pin can comprise a plurality of protrusions 320. Protrusion 320 can contact the components of the battery, such as, for example, cathode 314, and prevent the battery components from obstructing indentations 322. Thus, indentations 322 can provide flow channels that run along the major axis of battery 310. In some embodiments, batteries 300 and 310 can be lithium ion batteries. Materials suitable for the use as the cathode and anode of lithium ion batteries are generally described in U.S. Pat. No. 5,989,743 to Yamashita, titled “Non-Aqueous Battery,” which is hereby incorporated by reference. In other embodiments, batteries 300 and 310 can be nickel-metal-hydride (NiMH) batteries. Materials suitable for the use in the electrodes of metal hydride batteries are described in, for example, U.S. Pat. No. 6,218,047 to Ovshinsky et al., titled “Active Electrode Compositions Comprising Raney Based Catalysts and Materials,” which is hereby incorporated by reference.

With reference to FIG. 9, an embodiment of a container for a battery is disclosed. In this embodiment, battery 400 comprises a cylindrical body 402, a cap 404, a bottom section 406, vent 408 and core pin 410. A shown in FIG. 9, body 402 is operably coupled to bottom section 402 and cap 404. Cap 404 can contain a vent that functions to release gases from inside the battery. In some embodiments, a vent may be present on bottom section 406 and/or body 402. Generally, vent 408 can comprise a pressure release valve, such that when a certain pressure is present inside battery 400, vent 408 opens and releases any gases present. As shown in FIG. 9, core pin 410 is positioned inside battery 400 such that gases traveling along the major axis of pin 400 can be released through vent 408.

The embodiments above are intended to be illustrative and not limiting. Additional embodiments are within the claims. Although the present invention has been described with reference to particular embodiments, workers skilled in the art will recognize that changes may be made in form and detail without departing from the spirit and scope of the invention.

1. A battery comprising:
an electrode structure comprising a cathode, an anode and a separator between the anode and the cathode; and
a core pin comprising a polymer and having a length along a direction generally indicated by a major axis, wherein the core pin comprises a flow channel in a direction along a major axis, and the wherein the separator, the anode and the cathode are wound around the core pin.

2. The battery of claim 1 wherein the core pin comprises a flow path within the interior of the core pin.

3. The battery of claim 1 wherein the core pin further comprises a plurality of notches provided in a spaced apart relationship along two opposite sides of the core pin wherein the plurality notches on one side of the core pin are staggered with respect to their position along the major axis relative to the plurality of notches on the opposite side.

4. The battery of claim 3 wherein the two opposite sides of the core pin each comprises a parallel set of notches.

5. The battery of claim 4 wherein each set of parallel notches is separated by a center support.

6. The battery of claim 3 wherein the core pin further comprises a plurality of passages that connect the notches on one side of the core pin with the notches on the opposite side.

7. The battery of claim 6 wherein the notches and the passages form the flow channel along an oscillating path.

8. The battery of claim 1 wherein the polymer is selected from the group consisting of polyethylene, polypropylene, poly(vinyl chloride) and poly(vinylidene fluoride).

9. The battery of claim 1 wherein the polymer comprises poly(vinylidene fluoride).

10. The battery of claim 1 wherein the polymer comprises electrically conductive fillers.

11. The battery of claim 10 wherein the electrically conductive fillers are selected from the group consisting of graphite, carbon black and metal powders.

12. The battery of claim 1 wherein the core pin comprises a plurality of protrusions that extend outward from the center of the core pin with the flow channel is formed by gaps between the outer surface of the core pin and the electrode structure with the electrode structure contacting the protrusions within the battery.

13. The battery of claim 14 wherein the core pin has six protrusions approximately symmetrically arranges around the major axis.

14. The battery of claim 13 wherein the protrusions are approximately uniform along the major axis.

15. A method for forming a vented battery, the method comprising:
sealing an electrode structure within a vented container comprising a pressure release valve, the electrode structure comprising a cathode, an anode and a separator between the cathode and the anode, wherein the electrode structure is wound around a core pin comprising a polymer and having a flow channel connecting the core pin with pressure release valve.

16. The method of claim 15 wherein the vented container has generally cylindrical shape.

17. The method of claim 15 wherein the vented container has a non-circular cross section perpendicular to the axis defining the winding.

18. The method of claim 15 wherein the flow channel is within the interior of the core pin.

19. The method of claim 15 wherein the flow channel is along the outer surface of the flow pin between the core pin and the electrode structure.

20. A core pin for a battery comprising electrically conductive particles in a polymer binder, wherein the core pin has a flow path through the interior of the pin to an end of the pin.
